(19) United States
(12) Patent Application Publication
(10) Pub. No.: US 2016/0052713 A1
(43) Pub. Date: Feb. 25, 2016

(54) Trash Can Device

(71) Applicant: Michael Paul, Martins Ferry, OH (US)

(72) Inventor: Michael Paul, Martins Ferry, OH (US)

(21) Appl. No.: 14/830,152

(22) Filed: Aug. 19, 2015

Related U.S. Application Data
(60) Provisional application No. 62/039,050, filed on Aug. 19, 2014.

(51) Int. Cl. B65F 1/06; B65F 1/14

(52) U.S. Cl. CPC B65F 1/068; B65F 1/1646

(57) ABSTRACT

A trash can device for assisting a user in lifting and removing a trash can liner from a trash can. The device includes a container having a base, one or more sidewalls, and an open upper end. The device further includes an interior volume in which a trash can liner can be placed. The sidewalls comprise an upper end and a lower end. The lower end of at least one sidewall includes one or more recessed foot supports that serve as footholds, allowing the user to hold the trash can in place with his or her foot while removing the trash can liner therefrom. The device further includes a lid removably attached to the open upper end of the container so to conceal the garbage therein and one or more handles permanently affixed to the sidewalls to allow the user to lift or move the device.

### CROSS REFERENCE TO RELATED APPLICATION

This application claims the benefit of U.S. Provisional Application No. 62/039,050 filed on Aug. 19, 2014. The above identified patent application is herein incorporated by reference in its entirety to provide continuity of disclosure.

### BACKGROUND OF THE INVENTION

### Field of the Invention

The present invention relates to trash can devices. More specifically, the present invention provides a trash can device that allows a user to hold the trash can in place with his or her foot while removing the trash can liner therefrom. The device includes a container having a base, one or more sidewalls, and an open upper end, defining an interior volume. The sidewalls include a lower end and an upper end. The lower end of the sidewalls further comprise one or more foot supports adapted to receive a user's foot therein. The device further comprises a lid adapted to be removably attached to the open upper end of the container.

It can be difficult to remove a trash can liner from a trash can. As the trash can liner fills with garbage, it fits tightly within the trash can, and the user may be required to hold the trash can steady while simultaneously lifting the bag out of the trash can. Alternatively, a first person may hold the trash can while a second person lifts the bag. This can be difficult and inconvenient, and requires the user to hold the trash can, which may be dirty or unsanitary.

Devices have been disclosed in the prior art that relate to trash can devices. These include devices that have been patented and published in patent application publications. Many of these devices generally relate to using a pedal system to lift the lid of a trash can and remove the liner thereafter without using any type of foot supports. Such devices include U.S. Pat. No. 6,102,343 to Grimesey et al. and U.S. Pat. No. 7,225,943 to Yang and Sandor. These devices, however, fail to provide foot supports in one or more sidewalls that allow the user to hold the trash can in place with his or her foot while removing trash can liner therefrom.

Other devices generally relate to using a foot pedal located on the outer perimeter of a receptacle to hold down the receptacle while removing a liner therein. Such devices include U.S. Pat. No. 5,163,579 to Jones and U.S. Pat. No. 6,739,565 to Spadafora. These devices, however, fail to provide foot supports located in one or more sidewalls that allow the user to hold the trash can in place with his or her foot while removing a trash can liner therefrom.

One other device, U.S. Pat. No. 5,690,247 to Boover, generally relates to using a recess located at the base of a receptacle to hold down the receptacle while removing a liner therein. This device, however, fails to provide more than one foot support and, furthermore, the foot support is not located in one or more sidewalls that allow the user to hold the trash can in place with his or her foot while removing a trash can liner therefrom.

In light of the devices disclosed in the prior art, it is submitted that the present invention substantially diverges in design elements from the prior art and consequently it is clear that there is a need in the art for an improvement to existing trash can devices. In this regard the instant invention substantially fulfills these needs.

### SUMMARY OF THE INVENTION

In view of the foregoing disadvantages inherent in the known types of trash can devices now present in the prior art, the present invention provides a new trash can device wherein the same can be utilized for providing convenience for the user when removing a trash can liner from a trash can.

It is therefore an object of the present invention to provide a new and improved trash can device that has all of the advantages of the prior art and none of the disadvantages.

It is another object of the present invention to provide a trash can device comprising a container having a base, one or more sidewalls, and an open upper end, defining an interior volume, wherein the sidewalls further comprise one or more foot supports adapted to receive a user's foot therein allowing the user to hold the trash can in place with his or her foot while removing the trash can liner therefrom

Another object of the present invention is to provide a trash can device wherein the open upper end of the container includes a lid removably secured thereon.

Another object of the present invention is to provide a trash can device having handles permanently affixed to the container and a lid pivotally attached to the container by means of a hinge.

Another object of the present invention is to provide a trash can device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the trash can device.

FIG. 2 shows a rear perspective view of an embodiment of the trash can device.

FIG. 3 shows a side cross sectional view of an embodiment of the trash can device.

FIG. 4 shows a perspective view of an embodiment of the trash can device in use.

### DETAILED DESCRIPTION OF THE INVENTION

Reference is made herein to the attached drawings. Like reference numerals are used throughout the drawings to depict like or similar elements of the trash can device. For the purposes of presenting a brief and clear description of the present invention, the preferred embodiment will be discussed as used for removing a trash can liner from a trash can. The figures are intended for representative purposes only and should not be considered to be limiting in any respect.

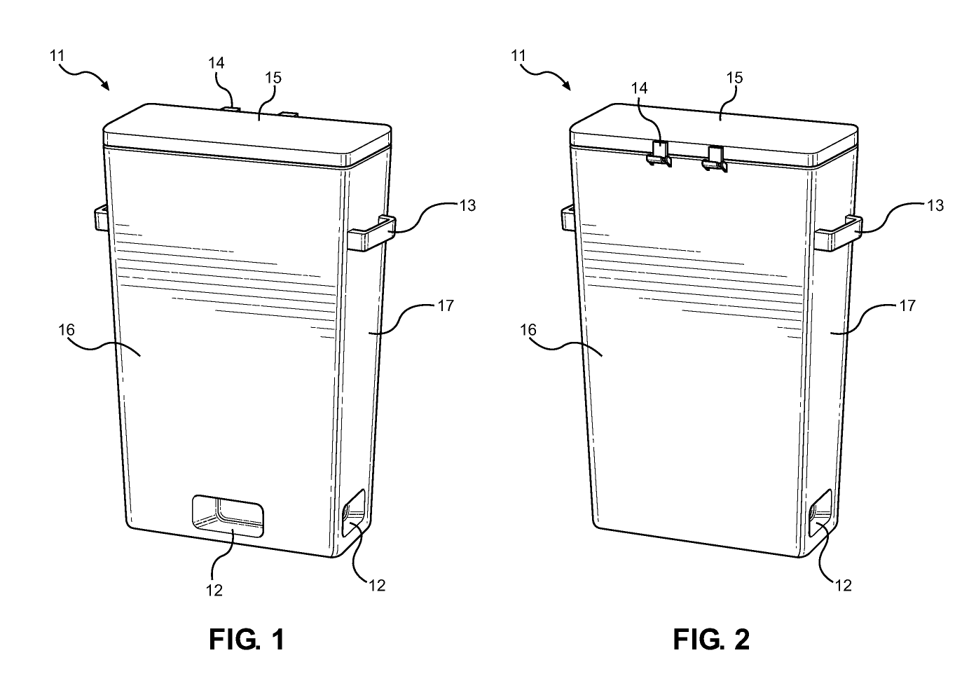

Referring now to FIGS. 1 and 2, there is shown a perspective view and a rear perspective view of an embodiment of the trash can device, respectively. The trash can device 11 comprises a container 17 having a base, one or more sidewalls 16, and an open upper end, defining an interior volume in which a trash can liner can be positioned. The sidewalls 16 include a lower end and an upper end, wherein one or more foot supports 12 are disposed at the lower end of at least one sidewall 16. The trash can device 11 further comprises a lid 15 adapted to be removably attached to the open upper end of the container 17.

The open upper end of the container 17 is removably covered by a lid 15 that is pivotally attached thereto by a hinge 14 disposed on the upper end of a sidewall of the container 17. The lid 15 can be used to seal the trash can device 11 so to keep animals from accessing the interior of the container 17 and to prohibit foul smells from leaving the container 17. The trash can device 11 can be maintained in a closed position via a locking mechanism, such as a latch. The container 17, lid 15, and hinge 14 can be composed of plastic or other suitable material. In some embodiments, the open upper end of the container 17 can have a lip around the perimeter and the lid 15 can include a groove around its perimeter, thereby creating a seal when the lid 15 is disposed on the container 17. In this way, the device 11 maintains closure while allowing a user to completely detach the lid 15 from the container 17 if he or she desires.

A user can lift or move the trash can device 11 by grabbing and holding one or more handles 13 that can be disposed on opposing sides of the container 17. The handles 13 can be permanently attached to the upper end of one or more sidewalls 16 by any suitable fastener, such as adhesive, glue, or screws, or may be integrally formed therewith. Each handle 13 preferably comprises a U-shape and the ends of the handle 13 are affixed to a sidewall of the container. Preferably, the handle is substantially perpendicular to the sidewall of the container such that the handles extend outward therefrom. The handles 13 are preferably identical and substantially rectangular in configuration. The handles 13 can be composed of plastic or other suitable material. In some embodiments, the trash can device may have one or more wheels disposed on the base of the container 17 to allow the user to roll the device 11 to a desired location.

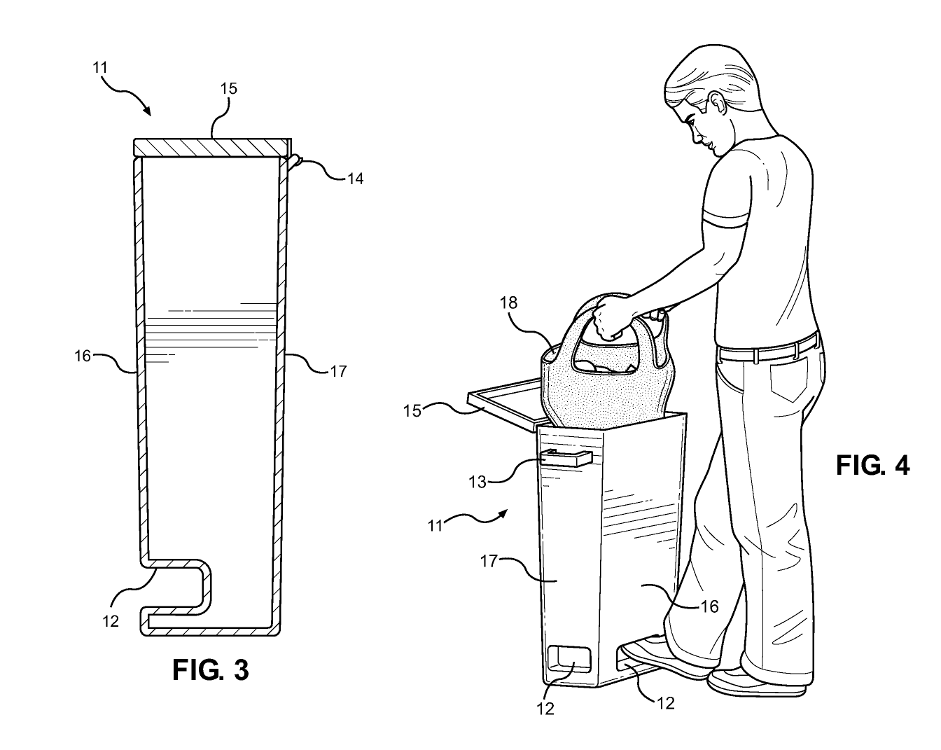

Referring now to FIG. 3, there is shown a cross sectional view of an embodiment of the trash can device. The trash can device 11 further includes one or more recessed foot supports 12 disposed in the lower end of a sidewall 16. The foot support 12 has an upper wall, a lower wall, a plurality of sidewalls, and an open outer surface adapted for a user's foot to be placed therein. The upper wall and lower wall of the foot support 12 are parallel to the base of the container 17, wherein the foot support is sized so as to receive a foot of a user therein. The user can rest the bottom of his or her foot on the lower wall of the foot support 12. The open outer surface of the foot support 12 can be vertically aligned with the sidewall 16 of the container 17. The foot support 12 is preferably substantially rectangular in configuration and is perpendicular to the sidewall. The recessed area of the foot support 12 extends into the interior volume of the container 17. The depth of the foot support 12 is enough to provide the necessary surface area to allow the user to hold down the trash can device 12 against the upward force that results from removing a trash can liner, but not so deep that the container 17 capacity is obstructed.

In some embodiments, the trash can device 11 includes a dividing wall used to separate the foot support 12 from the trash can liner. The dividing wall comprises a solid planar surface, where it can rest horizontally within the container 17. The perimeter of the dividing wall is preferably similar in configuration to the interior perimeter of the container so that it fits within the container 17 and is secured to the sidewalls thereof. The dividing wall can be permanently or removably affixed within the container 17 by any suitable fastener. In this way, the dividing wall creates an upper compartment in which a trash can liner can be positioned, and a lower compartment in which the one or more foot supports are positioned.

Referring now to FIG. 4, there is shown a perspective view of an embodiment of the trash can device in use. In operation, the user can uncover the open upper end of the container 17 by pivoting the lid 15 about the hinge 14. The user will then place his or her foot within the foot support 12 and grab ahold of the trash can liner 18. Next, while keeping his or her foot within the foot support 12, the user with lift the trash can liner 18 out of the container 17. As the liner is being lifted, the user can push his or her foot in a downward motion so to counteract the upward force created by pulling upward on the liner. The user can also move the container 17 to a desired location by grasping the handles 13 on the sidewalls 16 thereof.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A trash can device, comprising:
a container having a base, one or more sidewalls, and an open upper end, defining an interior volume;
said one or more sidewalls having a lower end and an upper end;
wherein said one or more sidewalls further comprises one or more foot supports adapted to receive a foot therein;
a lid removably securable to said open upper end of said container.

2. The trash can device of claim 1, wherein said upper end of said one or more sidewalls further comprises one or more handles permanently attached thereto.

3. The trash can device of claim 1, wherein said lid includes a fastener for securement to said open upper end of said container.

4. The trash can device of claim 1, wherein said lid is pivotally secured to said open upper end of said container by means of a hinge.

5. The trash can device of claim 1, wherein said one or more foot supports are disposed near said lower end of said one or more sidewalls.

6. The trash can device of claim 1, wherein said one or more foot supports comprise a substantially rectangular recessed area extending perpendicularly to a sidewall of said container.

7. The trash can device of claim 1, wherein said one or more foot supports extend from a sidewall into said interior volume of said container.
